(19) United States
(12) Patent Application Publication
(10) Pub. No.: US 2015/0110181 A1
(43) Pub. Date: Apr. 23, 2015

(54) METHODS FOR PALETTE PREDICTION AND INTRA BLOCK COPY PADDING

(71) Applicant: Samsung Electronics Co., Ltd., Suwon-si (KR)

(72) Inventors: Ankur Saxena, Dallas, TX (US); Guoxin Jin, Evanston, IL (US); Felix Carlos Fernandes, Plano, TX (US)

(21) Appl. No.: 14/518,883

(22) Filed: Oct. 20, 2014

Related U.S. Application Data
(60) Provisional application No. 61/923,527, filed on Jan. 3, 2014.
(60) Provisional application No. 61/893,044, filed on Oct. 18, 2013.

(51) Int. Cl. H04N 19/157; H04N 19/147; H04N 19/583; H04N 19/186; H04N 19/182

(52) U.S. Cl. CPC H04N 19/157; H04N 19/186; H04N 19/182; H04N 19/583; H04N 19/147
USPC 375/240.12; 375/240.25

(57) ABSTRACT

A method is provided that includes receiving a bitstream. The method also includes parsing the bitstream for a flag indicating whether a palette was used from a first or second coding unit. The method also includes decoding the first coding unit using the palette from the first or second coding unit indicated by the flag. The palette is determined based on which palette of the first or second coding unit improves compression performance. Also, a method is provided that includes receiving a bitstream with a predicted pixel. A coding unit and a reference unit are identified. A number of pixels of the coding unit and the reference unit overlap. A set of available pixels and a set of unavailable pixels of the reference unit are identified. The predicted pixel of the set of unavailable pixels is estimated as a pixel of the set of available pixels.

### CROSS-REFERENCE TO RELATED APPLICATION(S) AND CLAIM OF PRIORITY

The present application is related to U.S. Provisional Patent Application No. 61/923,527, filed Jan. 3, 2014, entitled “METHODS FOR PALETTE PREDICTION AND INTRA BLOCK COPY PADDING” and U.S. Provisional Patent Application No. 61/893,044, filed Oct. 18, 2013, entitled “METHOD FOR NEAREST NEIGHBOR BASED PLANAR PREDICTION AND MOTION VECTOR CODING IN INTRA BLOCK COPY MODES.” Provisional Patent Applications Nos. 61/923,527 and 61/893,044 are assigned to the assignee of the present application and are hereby incorporated by reference into the present application as if fully set forth herein. The present application hereby claims priority under 35 U.S.C. §119(e) to U.S. Provisional Patent Applications Nos. 61/923,527 and 61/893,044.

### TECHNICAL FIELD

The present application relates generally to a video encoder/decoder (codec) and, more specifically, to a method and apparatus for palette prediction and intra block copy padding.

### BACKGROUND

Various techniques for high bit-depths (more than 8 bits) for video sequences, lossless coding, visually lossless coding, screen content coding, coding of video in different color planes, other than YUV, such as RGB etc. are being investigated. Palette coding or Major Color coding is a technique that uses a few (N) pixels as a palette set (collection) of colors to predict other pixels within a Coding Unit (CU). Each pixel in a CU is labeled by one of the N colors in the palette which is closest to that pixel. As a result, the color in the palette, labels for each pixel and the prediction residue is the information to be coded. There are some variations of the technique in how to use and encode the palettes as well as the quantization steps.

### SUMMARY

This disclosure provides a method and an apparatus for palette prediction and intra block copy padding.

A first embodiment provides a method. A method is provided that includes receiving a bitstream. The method also includes parsing the bitstream for a flag indicating whether a palette was used from a first or second coding unit. The method also includes decoding the first coding unit using the palette from the first or second coding unit indicated by the flag. The palette is determined based on which palette of the first or second coding unit improves compression performance.

A second embodiment provides a decoder. The decoder includes receiving a bitstream. The decoder also includes parsing the bitstream for a flag indicating whether a palette was used from a first or second coding unit. The decoder also includes decoding the first coding unit using the palette from the first or second coding unit indicated by the flag. The palette is determined based on which palette of the first or second coding unit improves compression performance.

A third embodiment provides a method. The method includes receiving a bitstream with a predicted pixel. A coding unit and a reference unit for intra block copy coding of the coding unit are identified. A number of pixels of the coding unit and the reference unit overlap. A set of available pixels and a set of unavailable pixels of the reference unit are identified. The predicted pixel of the set of unavailable pixels is estimated as a pixel of the set of available pixels.

A fourth embodiment provides a decoder. The decoder includes receiving a bitstream with a predicted pixel. A coding unit and a reference unit for intra block copy coding of the coding unit are identified. A number of pixels of the coding unit and the reference unit overlap. A set of available pixels and a set of unavailable pixels of the reference unit are identified. The predicted pixel of the set of unavailable pixels is estimated as a pixel of the set of available pixels.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: “A,” “B,” “C,” “A and B,” “A and C,” “B and C,” and “A, B and C”.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates an example video encoder according to embodiments of the present disclosure;

FIG. 1B illustrates an example video decoder according to embodiments of the present disclosure;

FIG. 1C illustrates a detailed view of a portion of the example video encoder of FIG. 1A according to embodiments of the present disclosure;

FIG. 2A illustrates a block diagram of a palette coding process in accordance with embodiments of this disclosure;

FIG. 2B illustrates a block diagram of a palette decoding process in accordance with embodiments of this disclosure;

FIGS. 3A-3B illustrate diagrams for prediction using the CU's located to the left of the current CU in accordance with embodiments of this disclosure;

FIGS. 4A-4B illustrate diagrams for prediction using the CU's with different sizing than a current CU in accordance with embodiments of this disclosure;

FIGS. 5A-5B illustrate diagrams for prediction using the CU's different positions of the current LCU in accordance with embodiments of this disclosure;

FIGS. 6A-6B illustrate diagrams for padding for intra block copy in accordance with embodiments of this disclosure;

FIG. 7 illustrates an example method for encoding a coding unit with palette prediction according to embodiments of the present disclosure;

FIG. 8 illustrates an example method for encoding a coding unit with intra block copy according to embodiments of the present disclosure;

FIGS. 9A-9C illustrate diagrams for nearest neighbor planar intra prediction in accordance with embodiments of this disclosure; and

### DETAILED DESCRIPTION

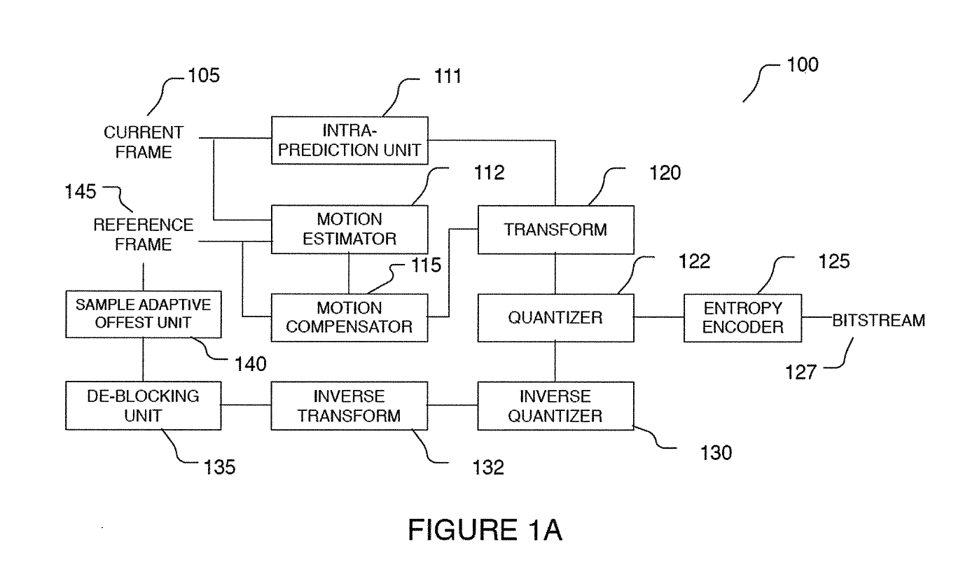

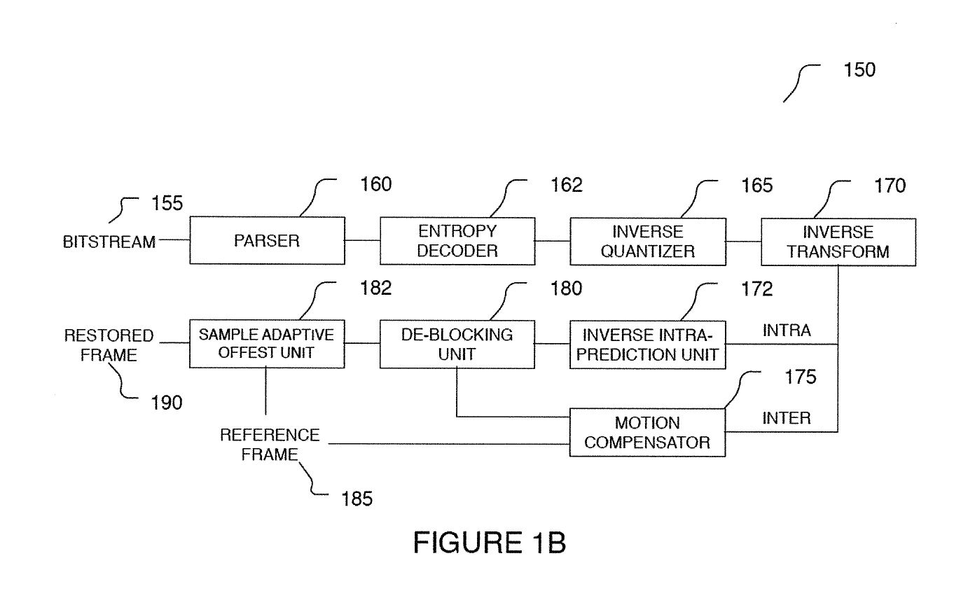

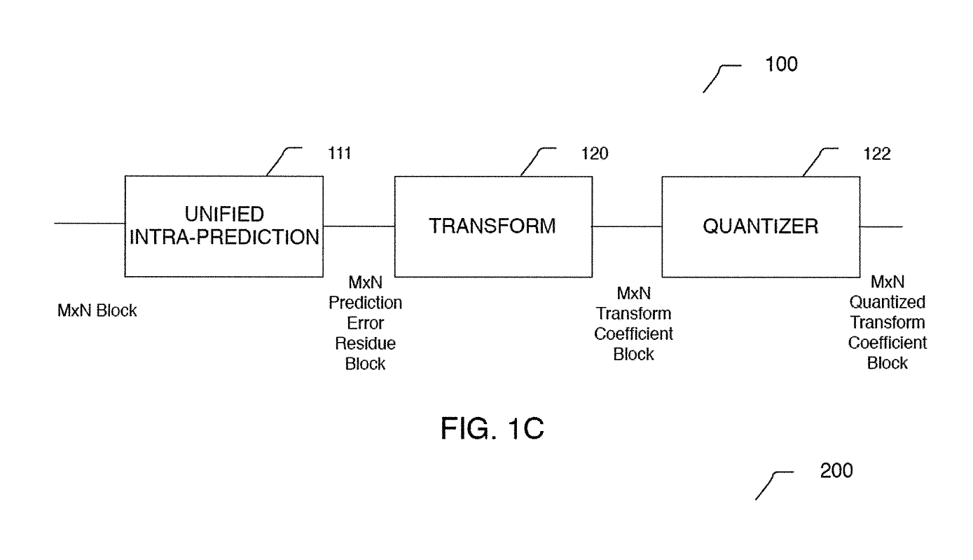

FIGS. 1A through 9C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. The wireless communication system may be referred to herein as the system. The system may include a video encoder and/or decoder.

FIG. 1A illustrates an example video encoder 100 according to embodiments of the present disclosure. The embodiment of the encoder 100 shown in FIG. 1A is for illustration only. Other embodiments of the encoder 100 could be used without departing from the scope of this disclosure.

As shown in FIG. 1A, the encoder 100 can be based on a coding unit. An intra-prediction unit 111 can perform intra prediction on prediction units of the intra mode in a current frame 105. A motion estimator 112 and a motion compensator 115 can perform inter prediction and motion compensation, respectively, on prediction units of the inter-prediction mode using the current frame 105 and a reference frame 145. Residual values can be generated based on the prediction units output from the intra-prediction unit 111, the motion estimator 112, and the motion compensator 115. The generated residual values can be output as quantized transform coefficients by passing through a transform unit 120 and a quantizer 122.

The quantized transform coefficients can be restored to residual values by passing through an inverse quantizer 130 and an inverse transform unit 132. The restored residual values can be post-processed by passing through a de-blocking unit 135 and a sample adaptive offset unit 140 and output as the reference frame 145. The quantized transform coefficients can be output as a bitstream 127 by passing through an entropy encoder 125.

FIG. 1B illustrates an example video decoder according to embodiments of the present disclosure. The embodiment of the decoder 150 shown in FIG. 1B is for illustration only. Other embodiments of the decoder 150 could be used without departing from the scope of this disclosure.

As shown in FIG. 1B, the decoder 150 can be based on a coding unit. A bitstream 155 can pass through a parser 160 that parses encoded image data to be decoded and encoding information associated with decoding. The encoded image data can be output as inverse-quantized data by passing through an entropy decoder 162 and an inverse quantizer 165 and restored to residual values by passing through an inverse transform unit 170. The residual values can be restored according to rectangular block coding units by being added to an intra-prediction result of an intra-prediction unit 172 or a motion compensation result of a motion compensator 175. The restored coding units can be used for prediction of next coding units or a next frame by passing through a de-blocking unit 180 and a sample adaptive offset unit 182. To perform decoding, components of the image decoder 150 (such as the parser 160, the entropy decoder 162, the inverse quantizer 165, the inverse transform unit 170, the intra prediction unit 172, the motion compensator 175, the de-blocking unit 180, and the sample adaptive offset unit 182) can perform an image decoding process.

Each functional aspect of the encoder 100 and decoder 150 will now be described.

Intra-Prediction (units 111 and 172): Intra-prediction utilizes spatial correlation in each frame to reduce the amount of transmission data necessary to represent a picture. Intra-frame is essentially the first frame to encode but with reduced amount of compression. Additionally, there can be some intra blocks in an inter frame. Intra-prediction is associated with making predictions within a frame, whereas inter-prediction relates to making predictions between frames.

Motion Estimation (unit 112): A fundamental concept in video compression is to store only incremental changes between frames when inter-prediction is performed. The differences between blocks in two frames can be extracted by a motion estimation tool. Here, a predicted block is reduced to a set of motion vectors and inter-prediction residues.

Motion Compensation (units 115 and 175): Motion compensation can be used to decode an image that is encoded by motion estimation. This reconstruction of an image is performed from received motion vectors and a block in a reference frame.

Transform/Inverse Transform (units 120, 132, and 170): A transform unit can be used to compress an image in inter-frames or intra-frames. One commonly used transform is the Discrete Cosine Transform (DCT).

Quantization/Inverse Quantization (units 122, 130, and 165): A quantization stage can reduce the amount of information by dividing each transform coefficient by a particular number to reduce the quantity of possible values that each transform coefficient value could have. Because this makes the values fall into a narrower range, this allows entropy coding to express the values more compactly.

De-blocking and Sample adaptive offset units (units 135, 140, and 182): De-blocking can remove encoding artifacts due to block-by-block coding of an image. A de-blocking filter acts on boundaries of image blocks and removes blocking artifacts. A sample adaptive offset unit can minimize ringing artifacts.

In FIGS. 1A and 1B, portions of the encoder 100 and the decoder 150 are illustrated as separate units. However, this disclosure is not limited to the illustrated embodiments. Also, as shown here, the encoder 100 and decoder 150 include several common components. In some embodiments, the encoder 100 and the decoder 150 may be implemented as an integrated unit, and one or more components of an encoder may be used for decoding (or vice versa). Furthermore, each component in the encoder 100 and the decoder 150 could be implemented using any suitable hardware or combination of hardware and software/firmware instructions, and multiple components could be implemented as an integral unit. For instance, one or more components of the encoder 100 or the decoder 150 could be implemented in one or more field programmable gate arrays (FPGAs), application specific integrated circuits (ASICs), microprocessors, microcontrollers, digital signal processors, or a combination thereof.

FIG. 1C illustrates a detailed view of a portion of the example video encoder 100 according to this disclosure. The embodiment shown in FIG. 1C is for illustration only. Other embodiments of the encoder 100 could be used without departing from the scope of this disclosure.

In screen content sequences, palettes in neighboring areas can be highly correlated, as large portion of neighboring regions are similar. For example in a text document image, many of regions consist of text with similar color composition. The state-of-art Palette Coding techniques do not fully utilize the correlation.

In an embodiment of this disclosure, a palette could be predicted from left CUs. In screen content video, the colors in the neighboring regions are close with high probability. Moreover, for the document type of sequence, such as text document, the number of colors in the palettes is small. This implies that the previously encoded palette can be a good candidate for predicting a current palette. The bits used in the encoding of the palette are quite large. Let the current CU be represented by x[n] where n is the zig-zag order of encoding. x[n−1] represents the previous encoded CU. xL[n] is the left neighboring CU and KU[n] is the above neighboring CU of x[n] respectively. In different example embodiments, the sizes of neighboring CUs may be different to x[n] and depend on the optimal code modes selected by Rate-Distortion Optimizer (RDO).

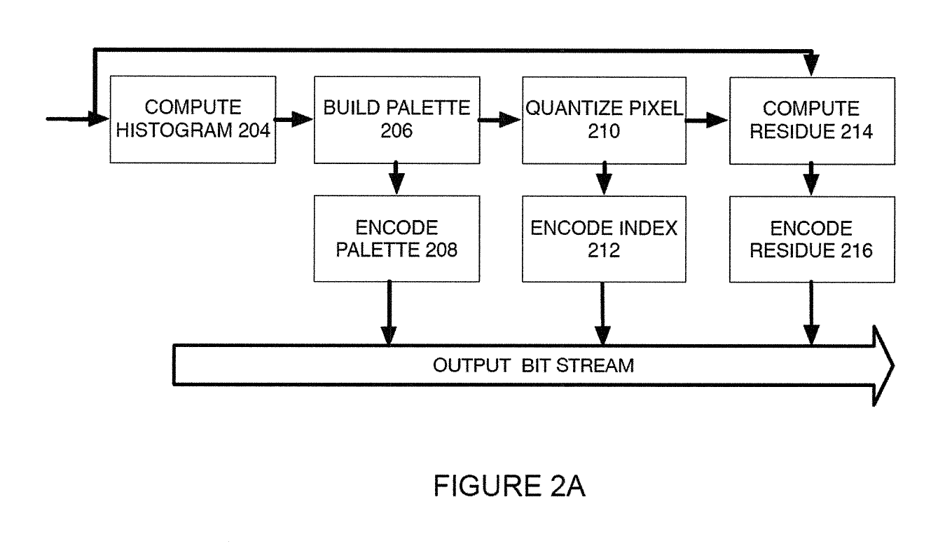

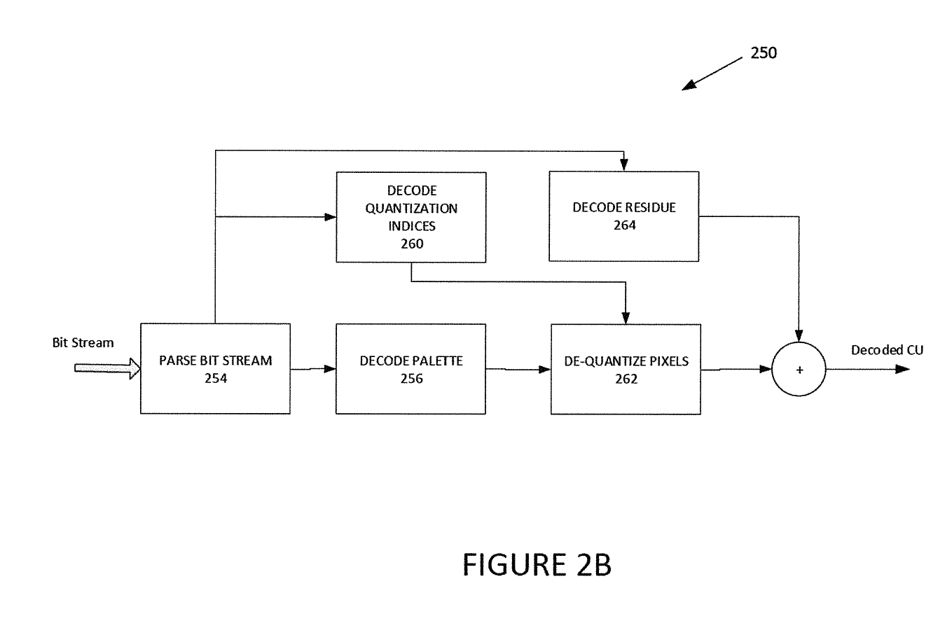

FIG. 2A illustrates a block diagram of a palette coding process in accordance with embodiments of this disclosure. Palette coding process 200 may be implemented in encoder 100 as show in FIG. 1A. Palette coding process 200 may encode a palette of a coding unit by creating a new palette or reusing a previously encoded palette.

At block 204, an encoder computes a histogram. At block 206, the encoder builds a palette using the histogram in block 204. At block 208, the encoder encodes the palette. At block 210, the encoder quantizes the pixel using the palette in block 206. At block 212, the encoder encodes an index of the pixel. At block 214, the encoder computes a residue. At block 216, the encoder encodes the residue. Afterwards, the encoded palette, index, and residue are output in a bit stream. The blocks of FIG. 2A are just an illustration of one example of the order of palette coding process 200. Other orders of the blocks may exist as well as some blocks may be added or subtracted. For example, blocks 214 and 216 may be optional for palette coding process 200.

FIG. 2B illustrates a block diagram of a palette decoding process in accordance with embodiments of this disclosure. Palette decoding process 200 may be implemented in decoder 150 as show in FIG. 1B. Palette decoding process 250 may decode a palette of a coding unit by using a new palette or reusing a previously encoded palette.

At block 254, a decoder parses a bit stream. The decoder may parse the bit stream for a flag indicating whether a palette is reused. At block 256, the decoder decodes a palette. At block 260, the decoder decodes the quantization indices. At block 262, the decoder de-quantizes the pixels. At block 264, the decoder decodes a residue. The blocks of FIG. 2B are just an illustration of one example of the order of palette decoding process 200. Other orders of the blocks may exist as well as some blocks may be added or subtracted. For example, block 264 may be optional for palette decoding process 250.

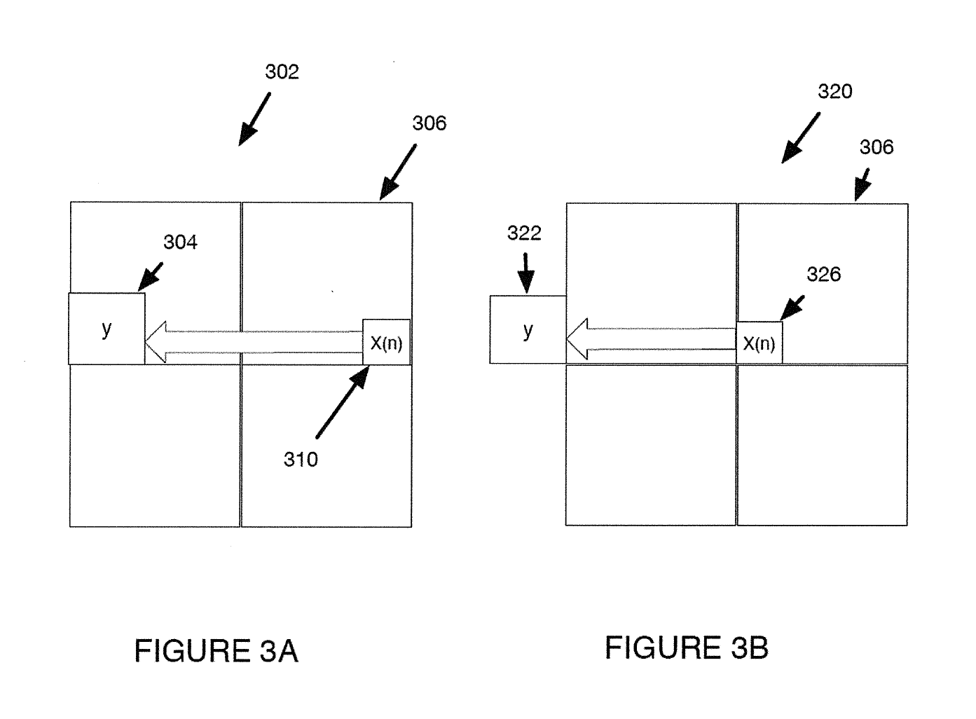

FIGS. 3A-3B illustrate diagrams for prediction using the CU's located to the left of the current CU in accordance with embodiments of this disclosure. In an example embodiment, only CU's located left of the current CU are considered since no data is required to encode the location of the left CU. Depending on the searching range, then schemes of the prediction may include, but not limited to, predicting within a Large Coding Unit (LCU), within a LCU and left LCU, and within a frame.

In an example, if the size of CU is different to the CUs to the left, a specific process can be done. Another alternative is, instead of searching the palette that is encoded previously, a current palette can be predicted by re-calculating the palette in the reconstructed pixels that are adjacent to current CU.

FIG. 3A illustrates a diagram 302 for predicting a palette from a left CU 304 (CU y) that resides in the same LCU 306 in accordance with an embodiment of the present disclosure. The embodiment of diagram 302 shown in FIG. 3 is for illustration only. Other embodiments of diagram 302 could be used without departing from the scope of this disclosure.

In a current LCU 306, during encoding of CU 310 (CU x[n]), the encoder keeps on searching to the left until it finds the first palette coded CU 304. Then the palette of CU 304 can be used directly as the palette of CU 310. If there are no CUs that are palette coded in the LCU 306, CU 310 will compute its own palette. Table 1 shows the scheme of diagram 302 in an algorithmic form for both the encoder, and decoder.

TABLE 1
Palette Prediction from Left CU in LCU

Encoder
Given a coding unit x[n]:
y = getLeftCU( x[n] )
while (y is a valid CU and y is in the same LCU as x[n])

if (y is a palette coded CU)

encode 1 for indicating there is a prediction
copy palette from y to x[n]
do palette coding for x[n] as in FIGURE 2A
return

else

y = getLeftCU(y)

endif

endwhile
encode 0 for indicating there isn't a prediction
compute palette of x[n] as in FIGURE 2A
encode palette of x[n] as in FIGURE 2A
do palette coding for x[n] as in FIGURE 2A
return
end
Decoder
Given a coding unit x[n]
read 1 bit
if bit is 0

decode palette of x[n] as in FIGURE 2B
decode x[n] as in FIGURE 2B
return

else

y = getLeftCU( x[n] )
while (y is a valid CU and y is in the same LCU as x[n])

if (y is a palette coded CU)

copy palette from y to x[n]
decode x[n] as in FIGURE 2B
return

else

y = getLeftCU(y)

endif

endwhile

endif
end

FIG. 3B illustrates a diagram 320 for predicting a palette from a left CU 322 (CU y) that resides in a left LCU in accordance with an embodiment of the present disclosure. The embodiment of diagram 320 shown in FIG. 3B is for illustration only. Other embodiments of diagram 320 could be used without departing from the scope of this disclosure.

In an example embodiment of diagram 302 of FIG. 3A, the CUs on the left boundary may not be used in prediction. In FIG. 3B, CUs coded as palette coding in left LCU can also be considered in addition to CU 326. In another example embodiment, if no CU is coded by palette coding, CU 326 (CU x[n]) will compute its own palette as the same as CU 310 in FIG. 3A. Table 2 shows the scheme of diagram 320 in an algorithmic form for both the encoder, and decoder.

TABLE 2
Palette Prediction from Left CU in LCU and left LCU

Encoder
Given a coding unit x[n]:
y = getLeftCU( x[n] )
while (y is a valid CU and y is in the same LCU as x[n] or y is in the left
LCU of x[n])

if (y is a palette coded CU)

encode 1 for indicating there is a prediction
copy palette from y to x[n]
do palette coding for x[n] as in FIGURE 2A
return

else

y = getLeftCU(y)

endif

endwhile
encode 0 for indicating there isn't a prediction
compute palette of x[n] as in FIGURE 2A
encode palette of x[n] as in FIGURE 2A
do palette coding for x[n] as in FIGURE 2A
return
end
Decoder
Given a coding unit x[n]
read 1 bit
if bit is 0

decode palette of x[n] as in [3]
decode x[n] as in FIGURE 2B
return

else

y = getLeftCU( x[n] )
while (y is a valid CU and y is in the same LCU as x[n] or y is in the
left LCU of x[n])

if (y is a palette coded CU)

copy palette from y to x[n]
decode x[n] as in FIGURE 2B
return

else

y = getLeftCU(y)

endif

endwhile

endif
end

In an example embodiment, the current frame CU x[n] can keep searching to the left until it finds the first palette coded CU, y. Then the palette of CU, y can be used directly as the palette of CU x[n]. If there is not any palette coded CU that exists, CU x[n] can compute its own palette. Table 3 shows the scheme in an algorithmic form for both the encoder, and decoder.

TABLE 3
Palette Prediction from Left CU in a frame

Encoder
Given a coding unit x[n]:
y = getLeftCU( x[n] )
while (y is a valid CU in current Frame)

if (y is a palette coded CU)

encode 1 for indicating there is a prediction
copy palette from y to x[n]
do palette coding for x[n] as in FIGURE 2A
return

else

y = getLeftCU(y)

endif

endwhile
encode 0 for indicating there isn't a prediction
compute palette of x[n] as in FIGURE 2A
encode palette of x[n] as in FIGURE 2A
do palette coding for x[n] as in FIGURE 2A
return
end
Decoder
Given a coding unit x[n]
read 1 bit
if bit is 0

decode palette of x[n] as in FIGURE 2B
decode x[n] as in FIGURE 2B
return

else

y = getLeftCU( x[n] )
while (y is a valid CU in current Frame)

if (y is a palette coded CU)

copy palette from y to x[n]
decode x[n] as in FIGURE 2B
return

else

y = getLeftCU(y)

endif

endwhile

endif
end

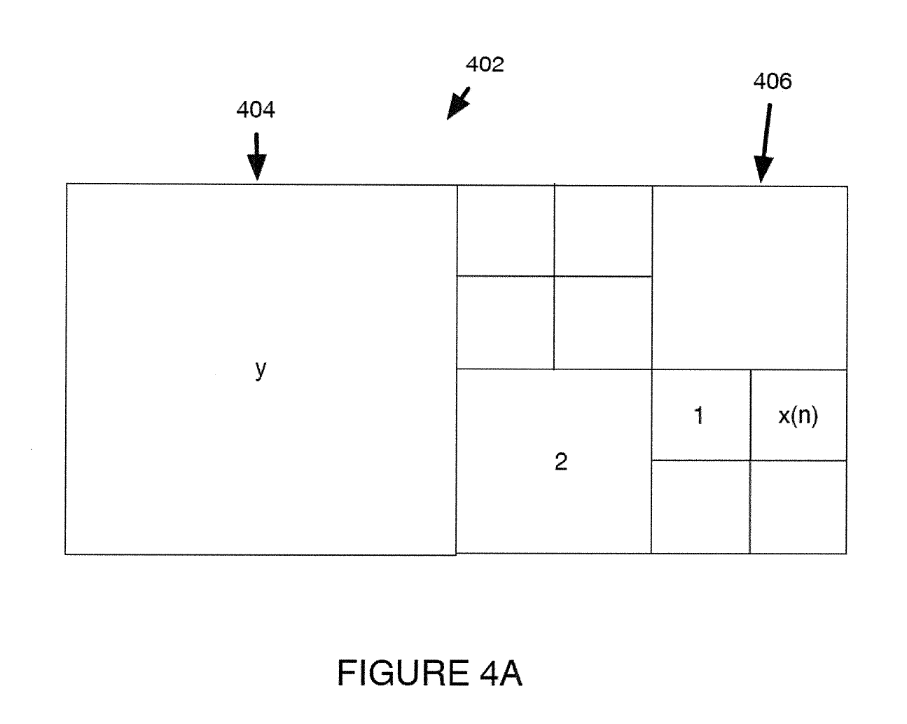

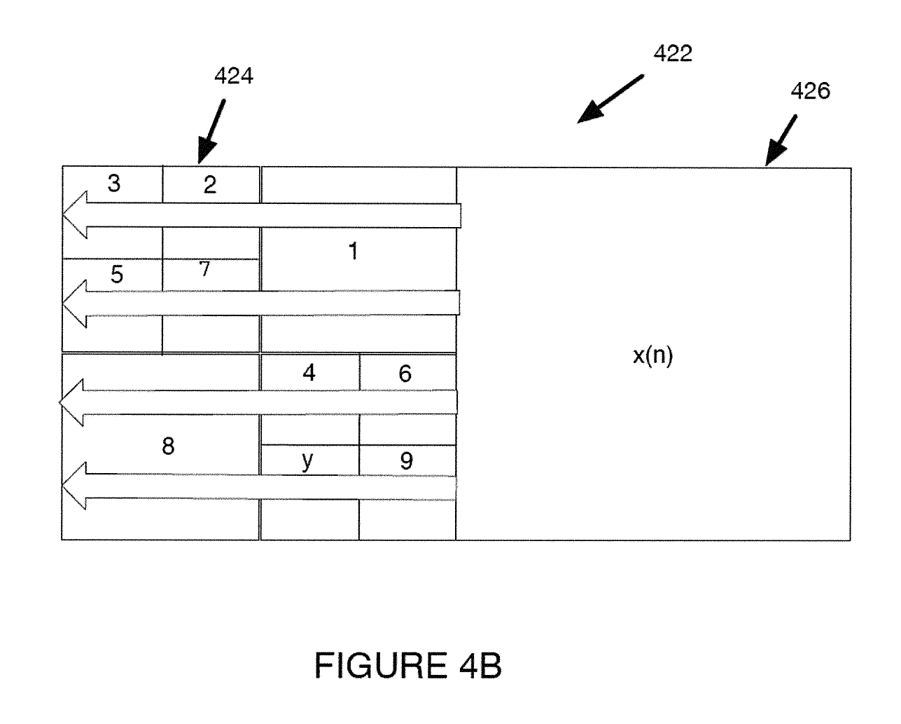

FIGS. 4A-4B illustrate diagrams for prediction using the CU's with different sizing than a current CU in accordance with embodiments of this disclosure.

FIG. 4A illustrates a diagram 402 for predicting a palette when a left CU 404 (CU y) size is greater than or equal to a current CU 406 (CU x[n]) size in accordance with an embodiment of the present disclosure. The embodiment of diagram 402 shown in FIG. 4 is for illustration only. Other embodiments of diagram 402 could be used without departing from the scope of this disclosure.

In the searching process, if current CU 406 has a different size to the left CUs, such as left CU 404 and other left CUs, CU 406 may miss the palette coded left CU 404. When current CU 406 size is smaller than or equal to the left CUs' such as left CU 404, CU 406 won't miss left CU 404. When left CU 404 is a palette coded CU to the left of current CU 406. The left search order will be 1, 2, then y.

FIG. 4B illustrates a diagram 422 for predicting a palette when a left CU 424 (CU y) size is less than a current CU 426 (CU x[n]) size in accordance with an embodiment of the present disclosure. The embodiment of diagram 422 shown in FIG. 4 is for illustration only. Other embodiments of diagram 422 could be used without departing from the scope of this disclosure.

In an example embodiment, the controller may use an anti-raster scan order as showed by the arrows. And the left CU 424 is visited in order are labeled by 1, 2, . . . 8, until the encoder search reaches y.

When CU 426 has a size greater than the minimum CU size (denoted by Nmin=8, for example), an anti-raster scan search can be applied in diagrams 302 and 320 of FIGS. 3A-3B. An algorithm for diagram 422 is showed in Table 4.

TABLE 4
Palette Prediction from Left CU When
Current CU size > Min CU Size

Encoder
Given a coding unit x[n]:
let N = size of x[n]
y = getLeftCU( x[n] )
z = sub-CU with size Nmin located same offset as x[n]
for row = 0:N/ Nmin − 1

while (y is a valid CU in current Frame) if ( y is a palette coded CU)

encode 1 for indicating there is a prediction
copy palette from y to x[n]
do palette coding for x[n] as in FIGURE 2A
return

else

y = getLeftCU(y)

endif

endwhile

```
  z = z move down to next sub-CU with size Nmin
  y = getLeftCU(z)
```

end for

encode 0 for indicating there isn't a prediction
compute palette of x[n] as in FIGURE 2A
encode palette of x[n] as in FIGURE 2A
do palette coding for x[n] as in FIGURE 2A
return

end
Decoder
Given coding unit x[n]
read 1 bit
if bit is 0

decode palette of x[n] as in FIGURE 2B
decode x[n] as in FIGURE 2B
return

else

y = getLeftCU( x[n] )
z = sub-CU with size Nmin located same offset as x[n]
for row = 0:N/ Nₘᵢₙ − 1

while (y is a valid CU in current frame)

if (y is palette coded CU)

copy palette from y to x[n]
decode x[n] as in FIGURE 2B
return;

else

y = getLeftCU(y)

endif

endwhile

z = z move down to next sub-CU with size Nₘᵢₙ

y = getLeftCU(z)

endfor

endif
end

One or more embodiments provide a process for recalculating a left CU palette. When y[n] is a neighboring CU to the left of current CU x[n], the palette of y[n] can be calculated based on reconstruction of both encoder and decoder, even if y[n] is not palette coded.

TABLE 5
Recalculate left CU palette

Encoder
Given a coding unit x[n]:
y = getLeftCU( x[n] )
if (y is a palette coded CU)

encode 1 for indicating there is a prediction
copy palette from y to x[n]
do palette coding for x[n] as in FIGURE 2A
return

else

encode 0 for indicating recalculation
compute palette y
copy palette of y to x[n]
do palette coding for x[n] as in FIGURE 2A

return
endif

end
Decoder
Given coding unit x[n]
read 1 bit
if bit is 0

y = getLeftCU( x[n] ) from reconstructed pixels

calculate palette of y to x[n]

decode x[n] as in FIGURE 2B
return

else

decode palette of x[n] as in FIGURE 2B
decode x[n] as in FIGURE 2B
return

endif
end

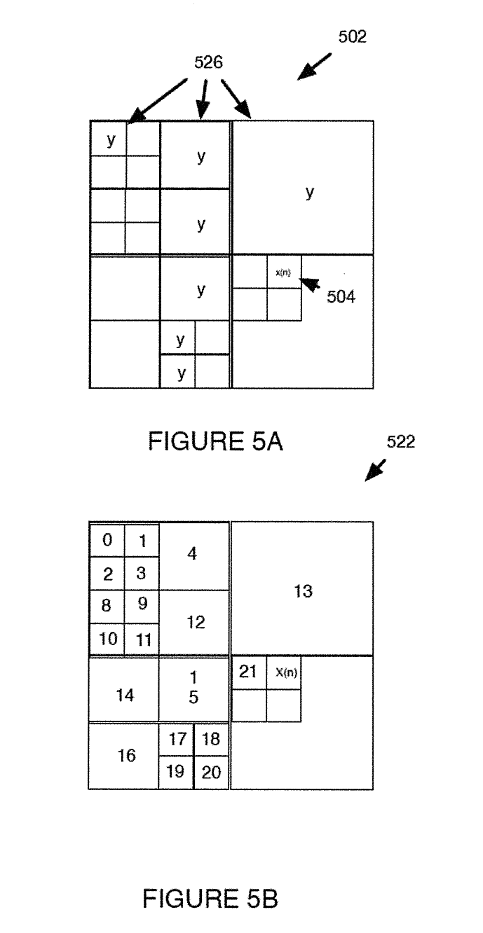

FIGS. 5A-5B illustrate diagrams for prediction using the CU's different positions of the current LCU in accordance with embodiments of this disclosure. One or more of the above example embodiments consider predicting palettes from the left region only. In further embodiments, there may be palettes encoded in the LCU that are located at other positions available for use. In an embodiment of this disclosure, a controller searches all the palette-coded CUs in a current LCU and uses the one which is most efficient with respect to minimum bit uses and distortion.

FIG. 5A illustrates a diagram 502 of possible predicting palettes in accordance with an embodiment of the present disclosure. The embodiment of diagram 502 shown in FIG. 5A is for illustration only. Other embodiments of diagram 502 could be used without departing from the scope of this disclosure. As shown in FIG. 5A, for CU 504 (CU x[n]), the entire previous palette coded CUs 526(CUs Y) can be examined.

FIG. 5B illustrates a diagram 522 of possible predicting palettes using a zig-zag order index in accordance with an embodiment of the present disclosure. The embodiment of diagram 522 shown in FIG. 5B is for illustration only. Other embodiments of diagram 522 could be used without departing from the scope of this disclosure. The embodiment in diagram 502 as shown in FIG. 5A may use signaling to identify palette has been reused. Since only the CUs in the LCU are checked (this can be trivially extended to all palette-coded CUs in a slice, or frame), the zig-zag order index (which is a 1-dimension index) can be used to indicate the previous palette location. For example, one embodiment of a zig-zag order index is shown in FIG. 5A.

In an example embodiment, when a current CU index is n and the previous CU index as m, the zig-zag index is then differentially coded as k=(n−m−1). Since n is can always be greater than m, this value is always greater than zero. For example, when n=22, if the best palette is the palette in CU x[15], then k=(22−15−1)=6.

For each CU x[n], a controller searches the entire palette coded CUs y[m] in the same LCU. Then the best y[m] (in the sense of Rate-Distortion cost) can be selected and k=(n−m−1) can be signaled.

One or more embodiments of this disclosure provide for, but not limited to, fixed-length code and Exponential-Golomb code encoding. In one example embodiment, the algorithm of palette prediction in LCU is shown in Table 6.

TABLE 6
Palette Prediction from all CU's in LCU

Encoder
Given a coding unit x[n]:
y[m] = getPreviousCUInZorder(x[n])
bestY = n
RDcost = infinity;
while (y[m] is a valid CU in LCU)

if (y[m] is a palette coded CU)

compute RD cost RDnew of :

encode 1 for indicating there is a prediction
encode k = n−m−1
copy palette from y to x[n]
do palette coding for x[n] as in FIGURE 2A

end compute RDnew
if RDnew < RDcost

bestY = m
RDcost = RDnew

endif

else

y = getPreviousCUInZorder(y)

endif

endwhile
if bestY==n

encode 0 for indicating no prediction
compute palette x[n]

encode palette of x[n] as in FIGURE 2A
else

encode 1 for indicating there is a prediction
encode k = n−m−1
copy palette from y to x[n]

endif

do palette coding for x[n] as in FIGURE 2A

return
end
Decoder
Given a coding unit x[n]
read 1 bit
if bit is 0

decode palette of x[n] as in FIGURE 2B
decode x[n] as in FIGURE 2B
return

else

decode k
m = n−k−1
y = getCU(m)
copy palette from y to x[n]
decode x[n] as in FIGURE 2B
return

endif
end

In one example embodiment, a controller encodes Motion Vector (MV) by fixed-length code. The max index N can be computed by (LCU Height*LCU Width)/(minimum CU area). So only B=ceil(log 2(N)) bits could be used to encode k. The controller uses B bit to encode each k.

In another example embodiment, a controller encodes MV by Exp-Golomb code. Variable length coding provides efficient coding due to neighboring regions being highly correlated, such that the probability of reusing close by palette could be higher than reusing further palettes. An Exponential Golomb code is a type of unary coding technique which has a longer codeword when the data value is large. The order of an Exp-Golomb code contributes to the performance of coding. Orders of 1, 2 and 3 or higher can be tested.

In an embodiment of this disclosure, a controller performs rate distortion mode selection of palette coding with palette prediction. In this disclosure, palette reusing could replace the current palette coding modes in HEVC. One or more embodiments of this disclosure provide for mixing Palette Coding and Palette Reusing. In an example embodiment, for each CU, both Palette Coding and Palette Reusing can be checked by a Rate-Distortion Optimizer and the most efficient is used in the coding process. Rate-distortion optimization is a method of improving video quality in video compression. Rate-distortion optimization refers to the optimization of the amount of distortion (loss of video quality) against the amount of data required to encode the video, the rate. Rate-distortion optimization acts as a video quality metric, measuring both the deviation from the source material and the bit cost for each possible decision outcome. The bits are mathematically measured by multiplying the bit cost by the Lagrangian multiplier, a value representing the relationship between bit cost and quality for a particular quality level. A lower rate-distortion cost can be considered to improve compression performance.

For example, an algorithm of this process is shown in Table 7,

TABLE 7
Palette Coding and Palette Reusing in RDO

Encoder
Given a coding unit x[n]:
compute the RDCost of palette coding as in FIGURE 2A, denote by d1
compute the RDCost of palette prediction in any of the above example
embodiments,
depended on which scheme is used, denote by d2
if ( no palette can be predicted from previous CUs)

encode 1 bit 0 to indicate use palette coding in FIGURE 2A

else

if (d1<d2)

encode 1 bit 0 to indicate use palette coding in FIGURE 2A

else

encode 1 bit 1 to indicate use proposed palette prediction
(depends on which scheme been used)

endif

end if
end
Decoder
Given a coding unit x[n]
decode 1 bit
if bit is 0

decode as in FIGURE 2B

else

decode as proposed depending on which scheme used in the encoder

endif
end

In different embodiments, if there are other modes except of palette coding mode (such as in HEVC12.1+RExt5.1, there are Angular prediction mode, Intra Block Copy and so on), proposed schemes can be one additional mode. Each node can be tested by RDO and the best mode of them is selected. In one example embodiment, the bits used to indicate the proposed mode are displayed in Table 8.

TABLE 8
Palette Coding Mode Bits

| Mode | Bit |
|---|---|
| No Palette Coding | 0 |
| Palette Coding mode as in FIG. 2A, encode | 10 |
| current palette | |
| Palette Prediction mode as shown above depending | 11 |
| on which scheme is used | |

One or more embodiments of this disclosure provides for early termination of Palette Reusing. In order to reduce the encoding time, early termination by an encoder trick can be introduced. For example, if current CU palette differs a lot to the previous palette under examination, no further test needs to be done for the current palette.

An embodiment of this disclosure recognizes and takes into account that the color in palette of a left CU and an above CU can be reused if the color in the aligned palette location is the same. Effectiveness of predicting from an above CU is less than predicting from a left CU. If there is no aligned color in the left and above CU equal to current color, then the color may be encoded. Otherwise, a flag bit is used to indicate the direction of prediction (whether left or above).

One or more embodiments of this disclosure predict aligned colors from a left CU using the signaling as shown in Table 9.

TABLE 9
Simplification of Bit Allocation of Palette
Prediction without prediction from above.

| Mode | Bits |
|---|---|
| No Aligned colors are same in left CU | 0 + bitDepth |
| Aligned color predicted from left CU | 1 |

An embodiment of this disclosure also tested the mode of no prediction at all; the signaling is shown in Table 10.

TABLE 10
Simplification of Bit Allocation of Palette Prediction without prediction
from left and above.

| Mode | Bits |
|---|---|
| Any color irrespective of alignment | bitDepth |

A prediction palette only from a left CU can achieve most of the gain as JCTVC-o0182 with simpler implementation.

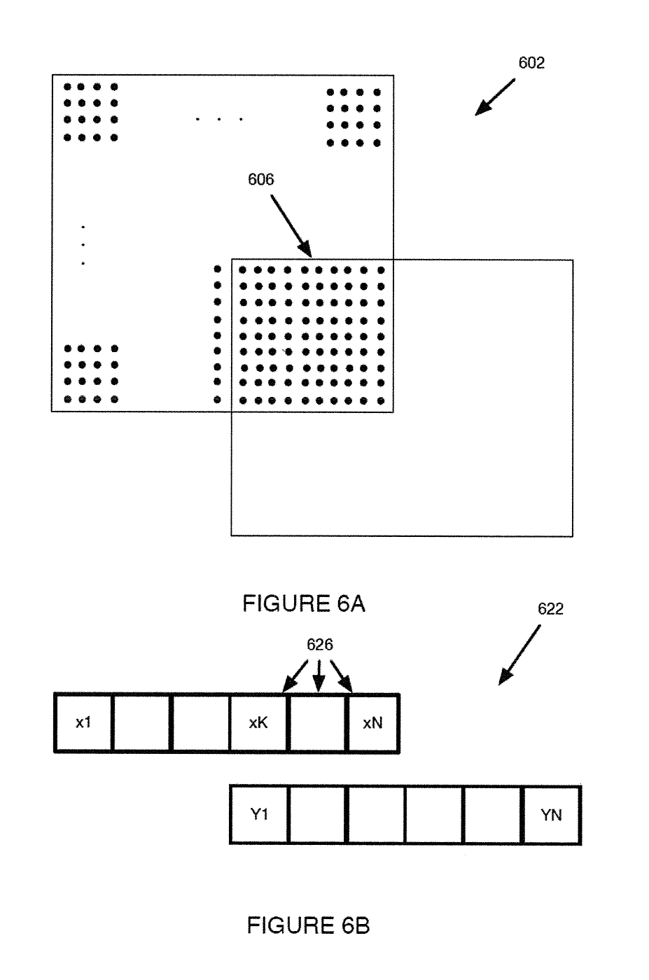

FIGS. 6A-6B illustrate diagrams for padding for intra block copy in accordance with embodiments of this disclosure. Embodiments of this disclosure recognize and take into account that various techniques for padding samples in Intra_Block Copy mode are being investigated. When the pixel samples are unavailable, and prediction needs to be performed from an overlapping block, the pixels can be predicted from the boundary pixels.

FIG. 6A illustrates a diagram 602 of predicting pixels from a boundary in accordance with an embodiment of the present disclosure. The embodiment of diagram 602 shown in FIG. 6A is for illustration only. Other embodiments of diagram 602 could be used without departing from the scope of this disclosure. In FIG. 6A, pixels can be predicted from the horizontal boundary in the reference block to all the unavailable pixels in the over-lapped region 606.

FIG. 6B illustrates a diagram 622 of filling pixels from an overlapping region in accordance with an embodiment of the present disclosure. The embodiment of diagram 622 shown in FIG. 6B is for illustration only. Other embodiments of diagram 622 could be used without departing from the scope of this disclosure.

In FIG. 6B, one or more embodiments of this disclosure provides a controller to fill the pixels in the over-lapping region 626 as follows, in the context of 1-dimension:

Let x1, x2, . . . , xK, be the available pixels in the reference block 624, and xK+1, xN (K<=N) be the pixels unavailable since they are in the over-lapped region 626. Also, let the actual pixels for which we need to predict in the current CU be denoted as y1, y2, . . . , yN−K, yN−K+1, yN. Note that y1=xK+1; yN−K=xN, and the like.

In an example embodiment, xK+1=x1, since the predictor for y1=xK+1 is being used as x1. So, for xK+1, the controller could use x1. Similarly for xK+2=x2, . . . , xN=xN−K.

In the above equation, the controller starts by obtaining the missing values for xK+1, xK+2, and the like. So, by the time the controller reaches xN, the controller would already have the value xN−K, either available in the reference pixels, or through recursion.

At both the encoder/decoder, the respective controllers follow the same technique. In another example embodiment, the controller uses this technique in vertical direction instead of horizontal, or a combination.

In another embodiment of this disclosure, search may not be constrained to a current LCU or a left LCU. Any LCU in the left could be selectively used.

In another embodiment of this disclosure, quantization error can be estimated at encoder and decoder, so the reconstruction inconsistency can be solved by using the same error estimation in encoder and decoder for any embodiments of this disclosure.

In another embodiment of this disclosure, arithmetic coding is also an option for encoding indexes any embodiments of this disclosure.

The different embodiments of this disclosure can improve the coding efficiency and reduce computational complexity of scalable extensions for HEVC.

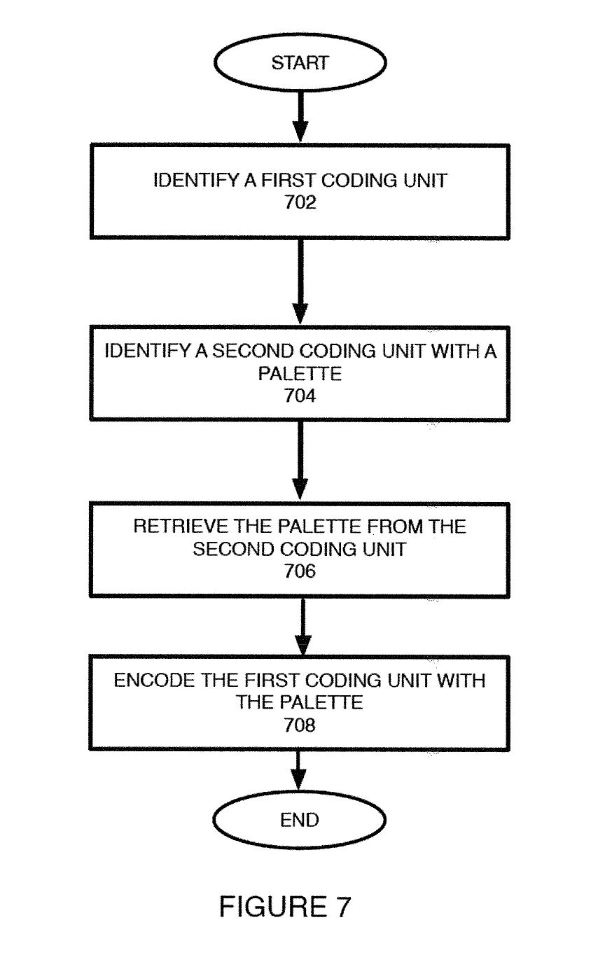

FIG. 7 illustrates an example method 700 for encoding a coding unit with palette prediction according to embodiments of the present disclosure. An encoder may perform method 700. The encoder may represent the encoder 100 in FIG. 1A. A controller may control the encoder. The controller may represent processing circuitry and/or a processor. The embodiment of the method 700 shown in FIG. 7 is for illustration only. Other embodiments of the method 700 could be used without departing from the scope of this disclosure.

At block 702, the encoder identifies a first coding unit. The first coding unit may be the current coding unit that is being predicted.

At block 704, the encoder identifies a second coding unit with a palette, the palette previously encoded. The second coding unit may be the first coding unit with a palette already encoded found by the encoder. In an embodiment, the second coding unit may be the coding unit with the most efficient or best match of a palette for the first coding unit. The efficiency can be determined by criteria. Criteria are represented by minimum bit uses and distortion. For example, the most efficient or best match coding unit may be the coding unit with the minimum bit use or least distortion.

At block 706, the encoder retrieves the palette from the second coding unit. The palette is copied and used for the first coding unit. At block 708, the encoder encodes the first coding unit with the palette.

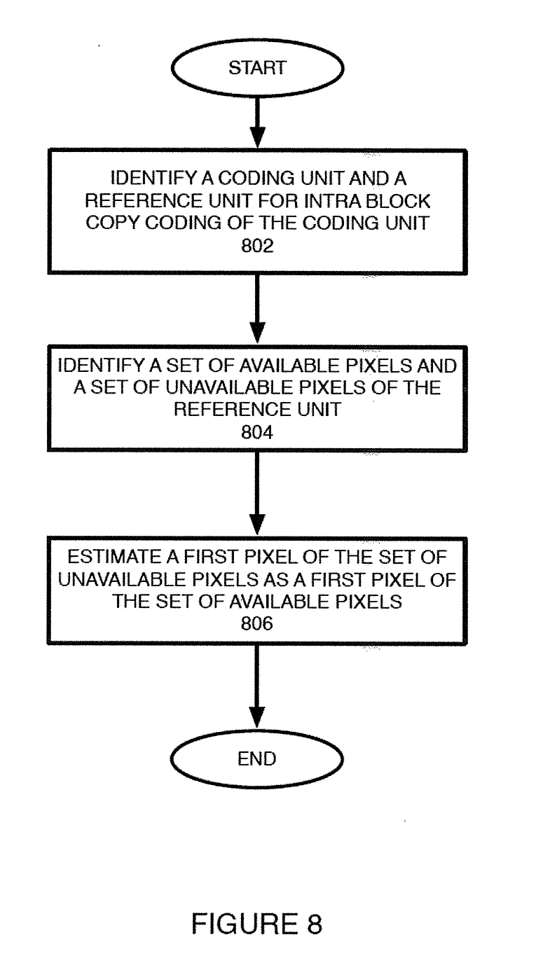

FIG. 8 illustrates an example method 800 for encoding a coding unit with intra block copy according to embodiments of the present disclosure. An encoder may perform method 800. The encoder may represent the encoder 100 in FIG. 1A. A controller may control the encoder. The controller may represent processing circuitry and/or a processor. The embodiment of the method 800 shown in FIG. 8 is for illustration only. Other embodiments of the method 800 could be used without departing from the scope of this disclosure.

At block 802, the encoder identifies the coding unit and a reference unit for intra block copy coding of the coding unit. The coding unit may be the unit to be coded and the reference unit is an already coded unit. A number of pixels of the coding unit and the reference unit overlap.

At block 804, the encoder identifies a set of available pixels and a set of unavailable pixels of the reference unit. The set of unavailable pixels may be the overlapping pixels. The set of available pixels may be the non-overlapping pixels.

At block 806, the encoder estimates a first pixel of the set of unavailable pixels as a first pixel of the set of available pixels.

One or more embodiments of this disclosure recognize and take into account that Intra prediction is a technique for predicting pixels by the other pixels which have been decoded and reconstructed. There are different modes for intra prediction in HEVC. For example, planar mode assumes the region is smooth and could be represented by linear interpolation of the pixels at the boundary. However, in the screen content sequences, the regions are not always smooth and a traditional planar intra prediction mode cannot predict the pixel accurately. Assuming there is an edge across a 1D signal; the pixels close to the edge can be incorrectly predicted if planar mode has been used. A piece-wise smooth regions exists more likely in the screen content sequences than in camera-captured content, and thus makes the traditional planar prediction to not perform efficiently on screen content. In piece-wise smooth screen content such as computer-generated graphics, traditional planar intra prediction mode may not work efficiently. It is desirable to find a better way to do planar intra prediction in screen content.

In order to encode the motion vectors obtained in Intra Block Copy mode, Exponential-Golomb code as a universal coding has previously been used. However, this is not optimal and needs to be improved, as the statistics for the motion vector do not necessarily follow an exponential distribution on which Exponential-Golomb code can work efficiently.

One or more embodiments of the present disclosure modify the planar intra prediction modes in HEVC using nearest neighboring pixels at the boundary and keeps using HEVC planar intra prediction modes otherwise.

One or more embodiments of the present disclosure show a simplified coding scheme works better than existing Exponential-Golomb code. Different embodiments using Huffman Coding are also disclosed herein for further improve coding efficiency.

One or more embodiments of the present disclosure show how intra planar prediction scheme and simplified intra block copy motion vector encoding are used for both the encoder and decoder. One or more embodiments of the present disclosure show example algorithms for both lossless and lossy scenarios.

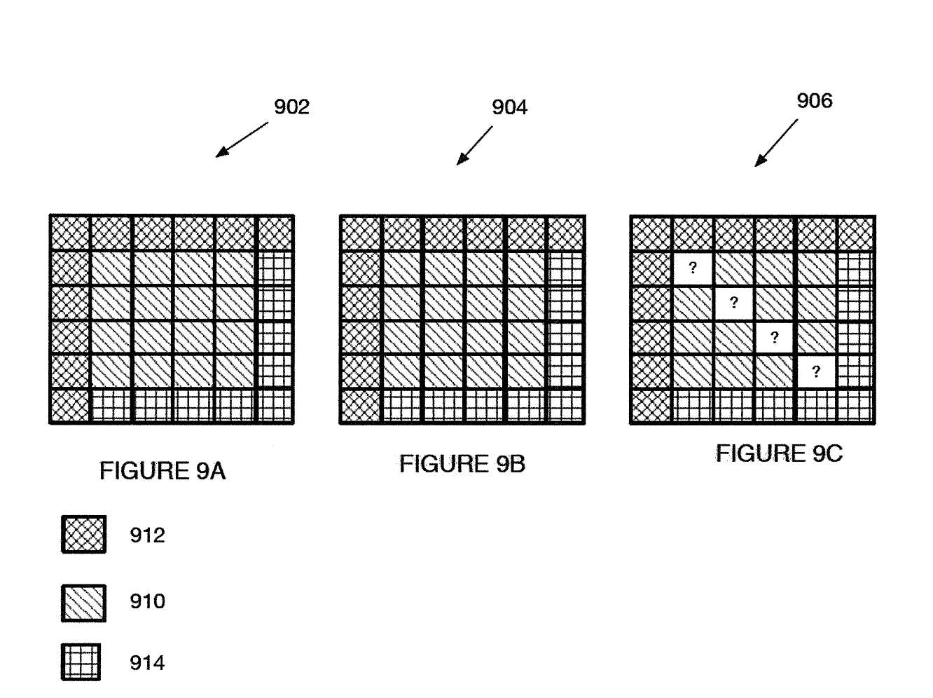

FIGS. 9A-9C illustrate diagrams 902-906 for nearest neighbor planar intra prediction in accordance with embodiments of this disclosure. The embodiment of diagrams 902-906 shown in FIGS. 9A-9C are for illustration only. Other embodiments of diagrams 902-906 could be used without departing from the scope of this disclosure. The procedure of nearest neighbor planar intra prediction mode is shown in FIGS. 9A-9C. Pixels 910 are the pixels to be predicted. Pixels 912 are pixels that have been decoded and reconstructed.

Diagram 902 illustrates pixels 914 being prepared. This process is the similar to HM12.0+RExt4.1. For each of pixels 910, diagram 904 illustrates predicting using the linear interpolation of top, left, right and bottom pixels 912-914 (boundary pixels). Diagram 904 illustrates predicting by selecting one of pixels 912-914 (boundary pixels) of which is closest to the predicted pixel in pixels 910. The pixels 916-924 on the diagonals of prediction unit can choose any boundary pixels 912-914 which are equally close, or their average.

In different example embodiments, preferences can be set to always choose left or top boundary pixels since they are actual reconstructed values and not bottom or right ones, since they are estimated, and not reconstructed pixels.

An embodiment of this disclosure provides a nearest neighbor planar intra prediction mode that is adaptive to the content. The “diversity” of the pixels on the boundaries is tested. If the diversity is greater than a threshold, the pixels can be predicted by its nearest boundary pixel value; otherwise, linear interpolation as in HM12.0+RExt4.1 can be used. This adaptation provides that for only the screen content pixels, which have large variation, nearest neighbor planar intra prediction mode can be used. The measurement of the diversity could be absolute differences, median value or standard deviation, variance, and the like.

For example, for a block of size M (rows)×N (cols), suppose the original pixel value is p(i,j) 0≦i<M−1; 0≦j≦N−1 the algorithm to predict pred (i,j) can summarized in Table 11. In an example of pixels on the anti-diagonal positions (i=N−j, or j=M−i), the prediction technique can select the nearest neighbor from left and top pixels instead of bottom row, or right column, since left and top pixels are reconstructed values. When the pixels are on diagonal positions, the prediction technique can choose between any of the two options (left and top), or can be just average of the top and left pixels. At the decoder, the same nearest neighborhood prediction can be applied.

TABLE 11
Nearest Neighbor Planar intra prediction mode.

Given reconstructed pixels on boundaries upRow and leftColumn
Let bottomLeft = leftColumn[M−1] and topRight=topRow[N−1]
for j=0 to N−1

bottomRow[j] = (bottomLeft +topRow[j])/2;

for i=0 to M−1

rightColumn[i] = (topRight + leftColumn[i])/2;

for each pixel(i,j)
if std(topRow[i], leftColumn[j], rightColumn[j], bottom[i]) > threshold

find smallest [i, j, N−j, M−i]
if i is the smallest

pred(i,j) = topRow[i];

else if j is the smallest

pred(i,j) = leftColumn[j];

else if N−j is the smallest

pred(i,j) = rightCloumn[j];

else if M−i is the smallest

pred(i,j) = bottomRow[i];

else if i==N−j are the smallest

pred(i,j) = topRow[i];

else if j==M−i are the smallest

pred(i,j) = leftColumn[j];

else if i==j are the smallest

pred(i,j) = (topRow[i]+leftColumn[j])/2

One or more embodiments of this disclosure provide intra block copy motion vector encoding. Intra Block Copy is useful in screen content, since screen content is likely to have similar regions locally. The embodiments of this disclosure recognize and take into account that Exponential-Golomb code does not work well to encode the motion vectors in Intra Block Copy modes. The embodiments of this disclosure provide that a modified fixed length code can be more efficient and have greater compression gains when using Huffman coding.

In an embodiment, by using HM12.0+RExt4.1, a controller generates histograms of horizontal and vertical motion vector values for Intra Block Copy in all the sequences. Based on the statistics of the histograms, the average length for the Exponential-Golomb code can be computed as 9.9 bits for horizontal motion vector, and 6.0 bits for vertical motion vector. In an example, the entropy for the distribution is 6.23 bits/symbol and 4.5 bits/symbols for horizontal and vertical motion vectors respectively. There can be a gap between the Exponential-Golomb code performances to the one which can achieved by a code which can approach entropy.

The motion vector coding for intra block copy in HM12.0+RExt4.1 can be summarized in Table 12. In an example, a bit indicates whether the motion vector is zero (in a particular direction), or not used. Then, an extra bit can be used to identify if the magnitude is greater than or equal to one. All the other values can then be coded by Exponential-Golomb code. Next, a one bit can be used to code the sign.

TABLE 12
Intra BC motion vector coding in HM12.0 + RExt4.1

Encoding
Given motion vector value x:
if x is 0, encode 0 and return
else

encode 1
if (abs(x) ==1)

encode 0

else

encode 1
encode abs(x)−2 using Exponential-Golomb code
encode sign

Decoding
read a bit
if bit is 0, return 0
else

read a bit
if bit is 1

read a bit
if bit is 1 return −1
else return 1

else

value = decode using exponential-Golomb code for successive
bits
read a bit
if bit is 1 return −(value+2)
else return (value+2)

Some typical codewords are shown in Table 13.

TABLE 13
Typical IntraBC
motion vector codes in HM12.0 + RExt4.1

| Value | Binary Code |
|---|---|
| 0 | 0 |
| 1 | 100 |
| −1 | 101 |
| 2 | 11000 |
| −2 | 11001 |

From Table 13, Exponential-Golomb code is more efficient if the value of motion vector is symmetric to zero and the probability density decreasing exponentially. Motion vectors may not be symmetric, and for a period of eight, there is a strong peak compared to the neighbor values, which violates the decreasing assumption. As a result, Exponential-Golomb code may work well for coding the Intra Block Copy motion vectors, especially for the Horizontal motion vectors.

One or more embodiments of this disclosure provide a simple fixed length coding scheme. When using HM12.0+RExt4.1, a range of horizontal motion vectors values for Intra Block Copy is between −120 to 56 (integers). An eight bit integer can cover all the values. The average length of Exponential-Golomb code used in HM12.0+RExt4.1 for horizontal motion vector is 9.9 bits. Embodiments of the present disclosure provide a fixed length coding scheme A in Table 14.1 which codes each motion vector value x by L bits.

TABLE 14.1
IntraBC motion vector value fixed length coding scheme A.

Encoding
Given motion vector value x:
if current coding unit is an intra block copy unit

use L bit fix length code for abs(x)
encode sign

else

retain coding in HM12.0+RExt4.1

Decoding
if current coding unit is an intra block copy unit

value = read L bits and convert to unsigned integer
read a bit
if bit is 1 return (−value)
else return (value)

else

retain decoding in HM12.0+RExt4.1.

In an embodiment, scheme B simplifies upon the existing coding technique in HM12.0+RExt4.1. In HM12+RExt4.1, the motion vector coder assumes value 0 happens more frequently than any other cases; so only one bit is used to represent value 0 as shown in Table 12. Scheme B in this disclosure simplifies the coding algorithm for encoding other values by using L bit fix length code. Table 14.2 shows the algorithm for Scheme B. The typical code words are shown in Table 5 for the two different schemes

TABLE 14.2
IntraBC motion vector value fixed length coding scheme B.

Encoding
Given motion vector value x:
if current coding unit is an intra block copy unit

if x is 0, encode 0 and return
else

encode 1
use L bit fix length code for abs(x)
encode sign

else

retain coding in HM12.0+RExt4.1

Decoding
if current coding unit is an intra block copy unit

read a bit
if bit is 0 return 0
else

value = read L bits and convert to unsigned integer
read a bit
if bit is 1 return (−value)
else return (value)

else

retain decoding in HM12.0+RExt4.1.

TABLE 15
Typical IntraBC horizontal motion vector codes for Fixed Length Code.

| | Binary Code | Binary Code |
|---|---|---|
| Value | Scheme A | Scheme B |
| 0 | 00000000 | 0 |
| 1 | 00000001 | 100000001 |
| −1 | 10000001 | 110000001 |
| 2 | 00000010 | 100000010 |
| −2 | 10000010 | 110000010 |

The average codeword length can be computed by using the distribution of motion vector values (as the probability density function). Given the probability density p(v) with v as the value of motion vector and the code length of that motion vector l(v), the average codelength is:

$$\overline{l} = {\sum }_{v = {v}_{min}}^{{v}_{max}} p ( v ) l ( v )$$

Average codeword length for different schemes is summarized in Table 16. From Table 16, fixed length coding Scheme A can be used for horizontal intraBC motion vectors and Scheme B can be used for vertical intraBC motion vectors. An encoder can prefer to use Scheme B for both horizontal and vertical orientations with a tiny degradation in performance (8.04 is just 0.5% more than 8), as Scheme B may be used over Scheme A for the vertical motion vectors.

TABLE 16
Average code word length for Intra BC motion vectors

| bits per Symbol | Scheme A | Scheme B | Exp-Golomb | Entropy |
|---|---|---|---|---|
| Horizontal MV | 8 | 8.04 | 9.90 | 6.23 |
| Vertical MV | 7 | 5.14 | 5.95 | 4.50 |

In an example, to further decrease the average code word length, Huffman coding is used. As in Scheme B, an encoder still separates zero and other situations. One bit is used to indicate zero or not. Then the magnitude is coded using Huffman code. A Huffman codebook can be built by using the distribution. Finally, the sign is coded by 1 bit. The coding algorithm is shown in Table 18. The code words are listed in Table 19 and the average code length is summarized in Table 18.

TABLE 17
IntraBC motion vector coding use Huffman codes

Encoding
Given motion vector value x:
if current coding unit is an intra block copy unit

if x is 0, encode 0 and return

else

encode 1
encode abs(x) with code word in Table 9
encode sign

else

retain coding in HM12.0+RExt4.1

Decoding
if current coding unit is an intra block copy unit

read a bit
if bit is 0 return 0
else

value = decode use code word in Table 9.
read a bit
if bit is 1 return (−value)
else return (value)

else

retain decoding in HM12.0+RExt4.1.

TABLE 18
Average code word length for Intra BC motion vectors

| | Scheme | | | | |
|---|---|---|---|---|---|
| bits per Symbol | A | Scheme B | Exp-Golomb | Huffman | Entropy |
| Horizontal MV | 8 | 8.04 | 9.90 | 7.73 | 6.23 |
| Vertical MV | 7 | 5.14 | 5.95 | 4.61 | 4.50 |

Compared to the average code length in Table 18, the Huffman code has the shortest length as expected. The addition cost incurred is in storing the code book in both encoder and decode side.

In one or more embodiments, full range Huffman coding can further improve the Horizontal motion vector case. Since horizontal motion vector is more distributed, and 0 value is not as dominant as that is in the vertical case, coding scheme without separate 0 values and other values are preferred.

Embodiments of the disclosure are not restricted to apply on HM12.0+RExt4.1 IntraBC tools. Any future proposed tools can also use this disclosure as a guide to encode motion vectors. Embodiments of the disclosure can be applied to inter-prediction and combined intra and inter prediction in video coding. It is applicable to any coding/compression scheme that uses predictive and transform coding. Embodiments of the disclosure can be applied to rectangular block sizes of different width and height as well as to non-rectangular region of interest coding in video compression such as for short distance intra prediction, Embodiments of the disclosure can improve the coding efficiency and reduce computational complexity of scalable extensions for HEVC.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A decoder comprising:
processing circuitry configured to:
receive a bitstream;
parse the bitstream for a flag indicating whether a palette was used from a first or second coding unit; and
decode the first coding unit using the palette from the first or second coding unit indicated by the flag.

2. The decoder according to claim 1, wherein the palette is determined based on which palette of the first or second coding unit improves compression performance.

3. The decoder according to claim 1, wherein a second palette from the second coding unit is used as the palette if the second coding palette improves compression performance compared to using a first palette from the first coding unit.

4. The decoder according to claim 1, wherein a first palette from the first coding unit is used as the palette if the second coding palette does not improve compression performance compared to using the first palette from the first coding unit.

5. The decoder according to claim 1, wherein a second palette from the second coding unit is used as the palette if the second coding unit with the second palette exists to a left of the first coding unit.

6. The decoder according to claim 1, wherein the first coding unit is within a large coding unit, and wherein a second palette from the second coding unit is used as the palette if the second coding unit with the second palette exists to a left of the first coding unit within the large coding unit.

7. The decoder according to claim 1, wherein the first coding unit is within a first large coding unit, and wherein a second palette from the second coding unit is used as the palette if the second coding unit with the second palette exists to the left of the first coding unit within the first large coding unit or a second large coding unit to a left of the first large coding unit.

8. The decoder according to claim 1, wherein the first coding unit is within a frame, and a second palette from the second coding unit is used as the palette if the second coding unit with the second palette exists to a left of the first coding unit within the frame.

9. The decoder according to claim 1, wherein the second coding unit with a second palette is a coding unit in a large coding unit that improves, compression performance the most compared to other coding units within the large coding unit.

10. The decoder according to claim 1, wherein each coding unit of a large coding unit comprise an index of a zigzag order, and the second coding unit is identified by an index of the second coding unit.

11. The decoder according to claim 2, wherein compression performance is based on a rate-distortion cost of a second palette from the second coding and a rate-distortion cost of a first palette from the first coding unit.

12. An decoder comprising:
processing circuitry configured to:
receive a bitstream with a predicted pixel, wherein a coding unit and a reference unit for intra block copy coding of the coding unit are identified, wherein a number of pixels of the coding unit and the reference unit overlap, a set of available pixels and a set of unavailable pixels of the reference unit are identified, and the predicted pixel of the set of unavailable pixels is estimated as a pixel of the set of available pixels.

13. The decoder according to claim 12, wherein the set of unavailable pixels are overlapping pixels.

14. A method for decoding, comprising:
receiving a bitstream;
parsing the bitstream for a flag indicating whether a palette was used from a first or second coding unit; and
decoding the first coding unit using the palette from the first or second coding unit indicated by the flag.

15. The method according to claim 14, wherein the palette is determined based on which palette of the first or second coding unit improves compression performance.

16. The method according to claim 14, wherein a second palette from the second coding unit is used as the palette if the second coding palette Improves compression performance compared to using a first palette from the first coding unit.

17. The method according to claim 14, wherein a first palette from the first coding unit is used as the palette if the second coding palette does not improve compression performance compared to using the first palette from the first coding unit.

18. The method according to claim 14, wherein a second palette from the second coding unit is used as the palette if the second coding unit with the second palette exists to a left of the first coding unit.

19. The method according to claim 14, wherein the first coding unit is within a large coding unit, and wherein a second palette from the second coding unit is used as the palette if the second coding unit with the second palette exists to a left of the first coding unit within the large coding unit.

20. The method according to claim 14, wherein the first coding unit is within a first large coding unit, and wherein a second palette from the second coding unit is used as the palette if the second coding unit with the second palette exists to the left of the first coding unit within the first large coding unit or a second large coding unit to a left of the first large coding unit.

21. The method according to claim 14, wherein the first coding unit is within a frame, and a second palette from the second coding unit is used as the palette if the second coding unit with the second palette exists to a left of the first coding unit within the frame.

22. The method according to claim 14, wherein the second coding unit with a second palette is a coding unit in a large coding unit that improves compression performance the most compared to other coding units within the large coding unit.

23. The method according to claim 14, wherein each coding unit of a large coding unit comprise an index of a zig-zag order, and the second coding unit is identified by an index of the second coding unit.

24. The method according to claim 15, wherein compression performance is based on a rate-distortion cost of a second palette from the second coding and a rate-distortion cost of a first palette from the first coding unit.

25. A method for decoding a coding unit, comprising:
receiving a bitstream with a predicted pixel, wherein a coding unit and a reference unit for intra block copy coding of the coding unit are identified, wherein a number of pixels of the coding unit and the reference unit overlap, a set of available pixels and a set of unavailable pixels of the reference unit are identified, and the predicted pixel of the set of unavailable pixels is estimated as a pixel of the set of available pixels.

26. The method according to claim 25, wherein the set of unavailable pixels are overlapping pixels.

27. An encoder comprising:
processing circuitry configured to:
identify a first coding unit;
identify a second coding unit with a palette, the palette previously encoded;
retrieve the palette from the second coding unit;
determine whether using the palette from the second coding unit improves compression performance compared to using a palette from the first coding unit; and
if the palette from the second coding unit improves compression performance, encode the first coding unit with the palette from the second coding unit.

28. A method for encoding a coding unit, comprising:
identifying a first coding unit;
identifying a second coding unit with a palette, the palette previously encoded;
retrieving the palette from the second coding unit;
determining whether using the palette from the second coding unit improves compression performance compared to using a palette from the first coding unit; and
if the palette from the second coding unit improves compression performance, encoding the first coding unit with the palette from the second coding unit.
